(19) United States
(12) Patent Application Publication
(10) Pub. No.: US 2024/0166960 A1
(43) Pub. Date: May 23, 2024

(54) RENEWABLE ARCTIC DIESEL PRODUCTION

(71) Applicant: EXXONMOBIL TECHNOLOGY AND ENGINEERING COMPANY, Annandale, NJ (US)

(72) Inventors: Samuel J. CADY, Morristown, NJ (US); Xiaochun XU, Basking Ridge, NJ (US); Shifang LUO, Annandale, NJ (US); Michael H. RING, Conroe, TX (US); Joseph E. GATT, Annandale, NJ (US)

(21) Appl. No.: 18/264,740

(22) PCT Filed: Feb. 9, 2021
(86) PCT No.: PCT/US2021/017283

§ 371 Date: Aug. 8, 2023

(51) Int. Cl. C10G 65/02

(52) U.S. Cl. CPC C10G 65/02; C10G 2300/1011; C10G 2300/304; C10G 2300/307; C10G 2400/04

(57) ABSTRACT

A method for producing renewable arctic diesel is provided herein. The method includes contacting a bio-derived feedstock with a hydrotreatment catalyst under effective hydrotreatment conditions to produce a hydrotreated feedstock and separating the hydrotreated feedstock into gas phase products and liquid phase products. The liquid phase products include an oxygen content of less than 0.4 wt % but greater than 10 ppm. The method also includes contacting the liquid phase products with a ZSM-48-based isomerization/dewaxing catalyst under effective isomerization/dewaxing conditions to produce an isomerized product stream including a change in cloud point (ΔCP) of 50 degrees ° C. or more. The method further includes separating the isomerized product stream into gas phase products and liquid phase products, as well as fractionating the liquid phase products to produce renewable naphtha and renewable arctic diesel with a cloud point of −20° C. or less and a yield of 80 wt % or more.

### FIELD OF THE INVENTION

The techniques described herein relate to renewable arctic diesel. More particularly, the techniques described herein relate to the high-yield production of renewable arctic diesel with suitable cold flow properties.

### BACKGROUND OF THE INVENTION

This section is intended to introduce various aspects of the art, which may be associated with embodiments of the present techniques. This discussion is believed to assist in providing a framework to facilitate a better understanding of particular aspects of the present techniques. Accordingly, it should be understood that this section should be read in this light, and not necessarily as admissions of prior art.

Arctic diesel is conventionally derived from petroleum. It is highly desirable to replace this petroleum product with a bio-derived renewable arctic diesel to achieve reduced carbon intensity and greenhouse gas emissions. However, producing renewable arctic diesel is difficult due to the inherent tension between the required cold flow properties and the chemical nature of the bio-derived feedstocks.

In conventional renewable diesel processes, suitable bio-derived feedstocks, such as plant oils and animal fats, are hydrogenated, producing a waxy product consisting primarily of n-paraffins with a cloud point of around 20-30° C. This relatively high cloud point renders conventional renewable diesel unsuitable for use as arctic diesel, since the most severe grades of arctic diesel require a cloud point of less than −30° C. Moreover, according to current techniques, a reduction in cloud point can be achieved by catalytic dewaxing, but the deep dewaxing required to produce arctic diesel typically results in significant yield loss as the diesel cracks to lighter components. For example, a conventional dewaxing catalyst has a diesel yield loss of around 0.33% per degree Celsius in cloud point reduction. Therefore, to achieve a 60° C. cloud point reduction, the diesel yield loss will be around 20%. Accordingly, there is a need for improved methods for the high-yield production of renewable arctic diesel with suitable cold flow properties.

### SUMMARY OF THE INVENTION

An embodiment described herein provides a method for producing renewable arctic diesel. The method includes contacting a bio-derived feedstock with a hydrotreatment catalyst under effective hydrotreatment conditions to produce a hydrotreated feedstock and separating the hydrotreated feedstock into first gas phase products and first liquid phase products, wherein the first liquid phase products include an oxygen content of less than 0.4 weight percent (wt %) but greater than 10 parts per million (ppm). The method also includes contacting the first liquid phase products with a ZSM-48-based isomerization/dewaxing catalyst under effective isomerization/dewaxing conditions to produce an isomerized product stream including a change in cloud point (ΔCP) of 50 degrees Celsius (° C.) or more as compared to the first liquid phase products. The method further includes separating the isomerized product stream into second gas phase products and second liquid phase products, as well as fractionating the second liquid phase products to produce a renewable naphtha product and a renewable arctic diesel product with a cloud point of −20° C. or less and a yield of 80 wt % or more.

In some embodiments, the method includes contacting the bio-derived feedstock with the hydrotreatment catalyst within a hydrotreatment reactor and contacting the first liquid phase products with the ZSM-48-based isomerization/dewaxing catalyst within a separate isomerization/dewaxing reactor. In other embodiments, the method includes contacting the bio-derived feedstock with the hydrotreatment catalyst and contacting the resulting hydrotreated effluent with the ZSM-48-based isomerization/dewaxing catalyst within a single reactor including one or more hydrotreatment stages and one or more isomerization/dewaxing stages.

In various embodiments, the method includes exposing the bio-derived feedstock to a first portion of a hydrogen-rich treat gas stream along with the hydrotreatment catalyst and exposing the first liquid phase products to a second portion of the hydrogen-rich treat gas stream along with the ZSM-48-based isomerization/dewaxing catalyst. In such embodiments, the method may also include recycling the first gas phase products and/or the second gas phase products for combination with the first portion of the hydrogen-rich treat gas stream.

In various embodiments, the effective hydrotreatment conditions and the effective isomerization/dewaxing conditions include a pressure of 200-5,000 pounds per square inch in gauge (psig), a weighted average bed temperature (WABT) of 260-400° C., a hydrogen-rich treat gas rate of 200-10,000 standard cubic feet of gas per barrel (scf/bbl), and a liquid hourly space velocity (LHSV) of 0.1-10.0 inverse hours (hr⁻¹). In addition, in various embodiments, the method includes determining the pressure for the effective isomerization/dewaxing conditions by balancing a higher isomerization activity of the ZSM-48-based isomerization/dewaxing catalyst at lower pressures against a lower catalyst deactivation rate for the ZSM-48-based isomerization/dewaxing catalyst at higher pressures. Furthermore, in various embodiments, the method includes determining the effective isomerization/dewaxing conditions such that the cloud point of the renewable arctic diesel product meets an arctic diesel cloud point specification.

In some embodiments, the renewable arctic diesel product includes a cetane rating of 85 or above. Moreover, in some embodiments, the method includes stacking the ZSM-48-based isomerization/dewaxing catalyst with a catalyst that selectively cracks high-molecular-weight molecules and contacting the first liquid phase products with the stacked catalyst to allow for a controlled combination of isomerization and cracking that provides the ΔCP of 50° C. or more.

Another embodiment described herein provides another method for producing renewable arctic diesel within a reaction system. The method includes introducing a bio-derived feedstock and a first portion of a hydrogen-rich treat gas stream into a hydrotreatment reactor and contacting the bio-derived feedstock with a hydrotreatment catalyst under effective hydrotreatment conditions within the hydrotreatment reactor. The method also includes separating a resulting hydrotreated feedstock into first gas phase products and first liquid phase products within a separation device, wherein the first liquid phase products include an oxygen content of less than 0.4 weight percent (wt %) but greater than 10 parts per million (ppm), as well as introducing the first liquid phase products and a second portion of the hydrogen-rich treat gas stream into an isomerization/dewaxing reactor that is configured to provide a change in cloud point (ΔCP) of 50 degrees Celsius (° C.) or more. The method further includes contacting the first liquid phase products with a ZSM-48-based isomerization/dewaxing catalyst under effective isomerization/dewaxing conditions within the isomerization/dewaxing reactor, separating a resulting isomerized product stream into second gas phase products and second liquid phase products within a fractionator, and fractionating the second liquid phase products within the fractionator to produce a renewable naphtha product and a renewable arctic diesel product with a cloud point of −20° C. or less and a yield of 80 wt % or more

In some embodiments, the method includes stacking the ZSM-48-based isomerization/dewaxing catalyst with a catalyst that selectively cracks high-molecular-weight molecules. In such embodiments, the method may also include contacting the first liquid phase products with the stacked ZSM-48-based isomerization/dewaxing catalyst within the isomerization/dewaxing reactor to allow for a controlled combination of isomerization and cracking that provides a ΔCP of 50° C. or more.

In various embodiments, the method includes combining the first gas phase products and/or the second gas phase products with the first portion of the hydrogen-rich treat gas stream for recycling back into the hydrotreatment reactor. Moreover, in various embodiments, the renewable arctic diesel product includes a cetane rating of 85 or above.

In various embodiments, the method includes determining the pressure for the isomerization/dewaxing conditions by balancing a higher isomerization activity of the ZSM-48-based isomerization/dewaxing catalyst at lower pressures against a lower catalyst deactivation rate for the ZSM-48-based isomerization/dewaxing catalyst at higher pressures. Moreover, in various embodiments, the method includes determining the isomerization/dewaxing conditions such that the cloud point of the renewable arctic diesel product meets an arctic diesel cloud point specification.

In some embodiments, the method includes pretreating the bio-derived feedstock to remove metals, gums, and other contaminants. Furthermore, in various embodiments, the effective hydrotreatment conditions and the effective isomerization/dewaxing conditions include a pressure of 200-5,000 pounds per square inch in gauge (psig), a weighted average bed temperature (WABT) of 260-400° C., a hydrogen-rich treat gas rate of 200-10,000 standard cubic feet of gas per barrel (scf/bbl), and a liquid hourly space velocity (LHSV) of 0.1-10.0 inverse hours (hr⁻¹).

### BRIEF DESCRIPTION OF THE DRAWINGS

Advantages of the present techniques may become apparent upon reviewing the following detailed description and drawings of non-limiting examples in which:

FIG. 1 is a schematic view of an exemplary reaction system for producing renewable arctic diesel according to embodiments described herein;

FIG. 2 is a graph showing the 138° C. conversion of the feedstock during the deep dewaxing process as a function of the change in cloud point (ΔCP);

FIG. 3 is a graph showing a comparison between the cetane rating and cloud point for the renewable arctic diesel described herein versus the cetane ratings and cloud points for the kerosene and diesel fractions of several hundred crudes that may be used to produce conventional arctic diesel;

FIG. 4 is a graph showing the ΔCP as a function of the inverse liquid hourly space velocity (i.e., 1/LHSV);

FIG. 5 is a graph showing the ΔCP as a function of the temperature (in ° F.);

FIG. 6 is a graph showing the ΔCP as a function of the pressure (in psig);

FIG. 7 is a process flow diagram of a method for producing renewable arctic diesel according to embodiments described herein; and

FIG. 8 is a process flow diagram of a more detailed, exemplary method for producing renewable arctic diesel according to embodiments described herein.

It should be noted that the figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION OF THE PREFERRED EMBODIMENTS

In the following detailed description section, the specific examples of the present techniques are described in connection with preferred embodiments. However, to the extent that the following description is specific to a particular embodiment or a particular use of the present techniques, this is intended to be for example purposes only and simply provides a description of the embodiments. Accordingly, the techniques are not limited to the specific embodiments described below, but rather, include all alternatives, modifications, and equivalents falling within the true spirit and scope of the appended claims.

### Definitions

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the terms “a” and “an” mean one or more when applied to any embodiment described herein. The use of “a” and “an” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., ±1%, ±5%, ±10%, ±15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “cetane rating” (or “cetane number”) refers to a numerical indicator of the combustion speed of a diesel fuel and the amount of compression needed to ignite the fuel or, in other words, a numerical indicator of how readily and completely the fuel will burn in a combustion chamber. Generally speaking, the higher the cetane rating, the faster the fuel will ignite and the more completely it will burn. The cetane rating is determined by comparing the combustion characteristics in a test engine with blends of reference fuels of known cetane ratings. Moreover, there are several different techniques for measuring the cetane rating of a fuel. The true cetane rating is measured by an engine test (i.e., according to ASTM D613). However, since this test is expensive and requires a large sample volume, the cetane rating is often reported as a cetane index, which is a proxy for the cetane rating that is calculated using standard empirical correlations (e.g. according to ASTM D976 or ASTM D4737). Alternatively, the cetane rating is reported as a derived cetane rating (e.g. according to ASTM D7668). Typical diesel fuels have a cetane rating of between around 40 to 60, although higher cetane ratings are preferable.

The “cloud point” of an oil is the temperature below which paraffin wax or other solid substances begin to crystallize or separate from the solution, imparting a cloudy appearance to the oil when the oil is chilled under prescribed conditions. Exemplary conditions for measuring cloud point are described in ASTM D7346 and ASTM D2500. The cloud point is an important property of fuel because the presence of solidified waxes can clog filters and negatively impact engine performance.

As used herein, the term “configured” means that the element, component, or other subject matter is designed and/or intended to perform a given function. Thus, the use of the term “configured” should not be construed to mean that a given element, component, or ats subject matter is simply “capable of” performing a given function but that the element, component, and/or other subject matter is specifically selected, created, implemented, utilized, and/or designed for the purpose of performing the function.

The term “catalytic dewaxing” (or simply “dewaxing”) refers to the conversion of at least some of the normal paraffin content of a feedstock. This may be accomplished by isomerization of n-paraffins and/or cracking. The primary purpose of dewaxing is to reduce the cloud point by separating or converting hydrocarbons within the feedstock that readily solidify in petroleum fractions, thus ensuring that the feedstock will remain fluid down to the lowest expected temperature of use. In operation, dewaxing is required when highly paraffinic oils are to be used in products (such as diesel fuels) that need to flow at low temperatures. These oils contain high-molecular-weight straight-chain and slightly-branched paraffins, which cause the oils to have high cloud points. In order to obtain adequately low cloud points, these waxes must be wholly or partly removed or converted. Furthermore, the term “deep catalytic dewaxing” (or simply “deep dewaxing”) refers to the extreme dewaxing process that is required to produce a renewable arctic diesel product that meets cloud point specifications for very cold environments.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

As used herein, the term “fluid” refers to gases, liquids, and combinations of gases and liquids, as well as to combinations of gases and solids, and combinations of liquids and solids.

The term “gas” is used interchangeably with “vapor,” and is defined as a substance or mixture of substances in the gaseous state as distinguished from the liquid or solid state. Likewise, the term “liquid” means a substance or mixture of substances in the liquid state as distinguished from the gas or solid state.

As used herein, the “Liquid Hourly Space Velocity (LHSV)” for a feed or portion of a feed to a reactor is defined as the volume of feed per hour relative to the volume of catalyst in the reactor.

The term “pressure” refers to a force acting on a unit area. A pressure value is typically expressed as a number of pounds per square inch (psi).

As used herein, the term “renewable diesel” refers to a hydrocarbon product produced from bio-derived feedstocks. Examples of typical feedstocks for renewable diesel production include diglycerides, monoglycerides, triglycerides, fatty acid methyl esters (FAME), free fatty acids, and the like, which are often derived from plant oils, animal fats, or algae oils. Relatedly, the term “bio-diesel” generally refers to a hydrocarbon product produced by blending varying proportions of bio-derived feedstocks with standard feedstocks. Renewable diesel is generally preferable over the more conventional bio-diesel because, in contrast to bio-diesel, renewable diesel contains very low concentrations of oxygenates and can therefore be used in concentrations of up to 100% in conventional diesel engines. Accordingly, there is no blending limit for renewable diesels. Furthermore, the term “renewable arctic diesel” refers to a special grade of renewable diesel that is suitable for use at extremely low temperatures, such as temperatures below around −20° C. As a result, cold flow properties, including cloud point, are a key parameter for renewable arctic diesel. (It should be noted that the term “winter diesel” is sometimes used interchangeably with the term “arctic diesel”.)

As used herein, the term “yield” (or “diesel yield”) refers specifically to the distillate yield of renewable arctic diesel produced within a suitable reaction system, where the term “distillate” generally refers to the diesel product distilled within the reaction system. Relatedly, the term “conversion” refers to the amount (in wt %) of the diesel range feed that is converted to lower-molecular-weight products during the dewaxing process. In particular, given a particular diesel cut point (CP), conversion is defined as

(Mass Feed>CP−Mass Product>CP)/(Mass Feed>CP)×100.

Moreover, the lower-molecular-weight products are then removed via distillation. Accordingly, the conversion has an inverse relationship with the yield since a higher degree of conversion results in a lower distillate yield.

In this discussion, a “Cx” hydrocarbon refers to a hydrocarbon compound that includes “x” number of carbons in the compound. A stream containing “Cx-Cy” hydrocarbons refers to a stream composed of one or more hydrocarbon compounds that includes at least “x” carbons and no more than “y” carbons in the compound. It is noted that a stream containing “Cx-Cy” hydrocarbons may also include other types of hydrocarbons, unless otherwise specified.

In this discussion, “Tx” refers to the temperature at which a weight fraction “x” of a sample can be boiled or distilled. For example, if 40 wt % of a sample has a boiling point of 350° F. or less, the sample can be described as having a T40 distillation point of 350° F. In this discussion, boiling points can be determined by a convenient method based on the boiling range of the sample. This can correspond to ASTM D2887, or for heavier samples, ASTM D7169.

In various aspects of the invention, reference may be made to one or more types of fractions generated during distillation of a feedstock, intermediate product, and/or final product. Such fractions may include naphtha fractions and distillate fuel fractions. Each of these fractions can be defined based on a boiling range, such as a boiling range that includes at least 90 wt % of the fraction, or at least 95 wt % of the fraction. For example, for naphtha fractions, at least 90 wt % of the fraction, or at least 95 wt % of the fraction, can have a boiling point in the range of 85° F. (29° C.) to 280° F. (138° C.). It is noted that 29° C. roughly corresponds to the boiling point of isopentane, a C5 hydrocarbon. For a distillate fuel fraction, at least 90 wt % of the fraction, or at least 95 wt % of the fraction, can have a boiling point of greater than 280° F. Fractions boiling below the naphtha range can sometimes be referred to as light ends.

Another option for specifying various types of boiling ranges can be based on a combination of T5 (or T10) and T95 (or T90) distillation points. For example, in some embodiments, having at least 90 wt % of a fraction boil in the naphtha boiling range can correspond to having a T5 distillation point of 29° C. or more and a T95 distillation point of 138° C. or less. In some embodiments, having at least 90 wt % of a fraction boil in the distillate boiling range can correspond to having a T10 distillation point of 138° C. or more.

In this discussion, the boiling range of components in a feedstock, intermediate product, and/or final product may alternatively be described based on a weight percentage of components that boil within a defined range. The defined range can correspond to a range with an upper bound, such as components that boil at less than 138° C. (referred to as 138° C.−); a range with a lower bound, such as components that boil at greater than 138° C. (referred to as 138° C.+); or a range with both an upper bound and a lower bound, such as 29° C.-138° C.

As used herein, the term “ZSM” refers to Zeolite Socony Mobil, which includes a number of zeolites, such as Zeolite Socony Mobil 48 (ZSM-48), that may be used as catalysts in oil refining. This type of zeolite is a member of a family of microporous solids known as “molecular sieves,” which have pore diameters that are similar in size to relatively small molecules and, thus, allow relatively small molecules to adsorb or pass through while relatively large molecules cannot.

Certain aspects and features are described herein using a set of numerical upper limits and a set of numerical lower limits. It should be appreciated that ranges from any lower limit to any upper limit are contemplated unless otherwise indicated. All numerical values are “about” or “approximately” the indicated value, and account for experimental errors and variations that would be expected by a person having ordinary skill in the art.

### Overview

According to conventional techniques, renewable diesel is produced via a two-stage process. The first stage is a hydrotreatment stage in which a bio-derived feedstock is hydrotreated within a hydrotreatment reactor for the removal of oxygen and the saturation of double bonds. This step yields an intermediate product consisting primarily of diesel-range n-paraffins. This intermediate product typically has an excellent cetane rating, e.g., generally above about 90, and low concentrations of sulfur and nitrogen, e.g., generally below about 5 parts per million (ppm), compared to conventional mineral diesel. However, due to its high cloud point, e.g., generally above about 20° C., the intermediate product is typically unsuitable for direct blending into diesel fuel.

Therefore, to reduce the cloud point, the intermediate product is sent to the second stage, which is a catalytic dewaxing stage. During the catalytic dewaxing stage, the cloud point of the intermediate product is reduced via either of two dewaxing methods (or a combination of the two dewaxing methods). The first dewaxing method, referred to as “cracking,” requires the selective cracking of the long-chain n-paraffins within the intermediate product to produce lower-molecular-weight products that have a suitably lower cloud point and/or may be removed by distillation. The second dewaxing method, referred to as “catalytic isomerization” or simply “isomerization”, requires the isomerization of straight-chain paraffins and substantially-straight-chain paraffins to a more branched species with suitably lower cloud points.

In general, it is preferable to dewax the intermediate product via isomerization because isomerization results in the highest yield of the desired renewable diesel product. Conventionally, high isomerization selectivity is achieved by using a shape-selective molecular sieve. However, regardless of the catalyst used, as the dewaxing severity increases (as measured by the change in cloud point (ΔCP) in degrees Celsius), the extent of cracking increases since it becomes increasingly difficult to further reduce the cloud point by isomerization. This effect is especially pronounced when practicing deep dewaxing, i.e., ΔCP above about 50° C. For example, the cloud point data shown below in Table 1 for C-18 isomers, which are a representative renewable diesel molecule, reveal that, in order to achieve a ΔCP above 50° C., an average of two or more branches must be added to every n-C-18 molecule. However, achieving this level of isomerization while minimizing cracking is extremely difficult.

TABLE 1
Cloud Point Data for C-18 Isomers

| | Cloud Point (CP) | Change in Cloud Point |
|---|---|---|
| C-18 Isomer | (° C.) | (ΔCP) (° C.) |
| n-octadecane | 28 | — |
| 2-methylheptadecane | 6 | 22 |
| 2,4-dimethylhexadecane | −21 | 49 |
| 2,4,6-trimethylpentadecane | −75 | 103 |

Furthermore, the production of renewable arctic diesel typically requires deep dewaxing to achieve suitably low cloud points. For example, EN 590 Class 4 Arctic Diesel has a cloud point specification of less than −34° C., requiring a reduction in cloud point of approximately 55-65° C. for a typical renewable diesel. As a result, previous techniques for producing renewable arctic diesel have suffered from low yields. For example, the production of renewable diesel with a conventional dewaxing catalyst typically results in a yield loss of around 0.33 weight percent (wt %) per degree Celsius in cloud point reduction. Using the example of renewable EN 590 Class 4 Arctic Diesel, this corresponds to a yield loss of around 20 wt %.

Accordingly, embodiments described herein provide improved techniques for the high-yield production of renewable arctic diesel with suitable cold flow properties. More specifically, according to embodiments described herein, renewable arctic diesel is produced by processing a suitable waxy, bio-derived feedstock using a ZSM-48-based isomerization/dewaxing catalyst under suitable dewaxing conditions. The produced renewable arctic diesel meets arctic diesel cold flow specifications at unexpectedly high cetane ratings and high yields. For example, techniques described herein may be used to successfully reduce the cloud point by more than 50° C., more than 60° C., or more than 70° C. In addition, performing the dewaxing process using the ZSM-48-based isomerization/dewaxing catalyst according to the techniques described herein may result in an arctic diesel yield improvement of over around 20-65% as compared to performing the dewaxing process with a conventional cracking-based dewaxing catalyst. In other words, the diesel yield may be approximately 84-93 wt % (or, in some cases, 80-95 wt %) according to the techniques described herein, as compared to a diesel yield of approximately 80 wt % or less according to previous techniques. Moreover, the resulting renewable arctic diesel may have an excellent cetane rating of, for example, between about 75 and 95. Notably, all of these improvements can be achieved using existing hardware. Therefore, minimal capital expenditures are required to upgrade to the improved renewable arctic diesel production techniques described herein.

### Bio-Derived Feedstock Options According to Embodiments Described Herein

Embodiments described herein may be used to produce renewable arctic diesel from any suitable type of bio-derived feedstock, where the term “bio-derived feedstock” refers to a hydrocarbon feedstock derived from a biological raw material source, such as vegetable, animal, fish, and/or algae. For example, suitable feedstocks include diglycerides, monoglycerides, triglycerides, fatty acid methyl esters (FAME), free fatty acids, and the like, derived from plant oils, animal fats, or algae oils. Moreover, according to embodiments described herein, a feedstock that has been pretreated to remove metals, gums, and other contaminants (such as refined, bleached, and deodorized (RBD) grade vegetable oil) is preferred.

As used herein, the term “vegetable oil” (or “vegetable fat”) refers generally to any plant-based material and can include fats/oils derived from plant sources, such as plants of the genus Jatropha. Generally, the biological sources used for the bio-derived feedstock can include vegetable oils/fats, animal oils/fats, fish oils, pyrolysis oils, and/or algae lipids/oils, as well as any components of such biological sources. In some embodiments, the biological sources specifically include one or more types of lipid compounds, where the term “lipid compound” generally refers to a biological compound that is insoluble in water, but soluble in nonpolar (or fat) solvents. Non-limiting examples of such solvents include alcohols, ethers, chloroform, alkyl acetates, benzene, and combinations thereof.

Major classes of lipids include, but are not necessarily limited to, fatty acids, glycerol-derived lipids (including fats, oils, and phospholipids), sphingosine-derived lipids (including ceramides, cerebrosides, gangliosides, and sphingomyelins), steroids and their derivatives, terpenes and their derivatives, fat-soluble vitamins, certain aromatic compounds, and long-chain alcohols and waxes. In living organisms, lipids generally serve as the basis for cell membranes and as a form of fuel storage. Lipids can also be found conjugated with proteins or carbohydrates, such as in the form of lipoproteins and lipopolysaccharides.

Examples of vegetable oils that can be used according to embodiments described herein include, but are not limited to, rapeseed (canola) oil, soybean oil, coconut oil, sunflower oil, palm oil, palm kernel oil, peanut oil, linseed oil, tall oil, corn oil, castor oil, jatropha oil, jojoba oil, olive oil, flaxseed oil, camelina oil, safflower oil, babassu oil, tallow oil, and rice bran oil. According to embodiments described herein, vegetable oils can also include processed vegetable oil material. Non-limiting examples of processed vegetable oil material include fatty acids and fatty acid alkyl esters. Alkyl esters typically include C₁-C₅ alkyl esters. One or more of methyl, ethyl, and propyl esters are preferred.

Examples of animal fats that can be used according to embodiments described herein include, but are not limited to, beef fat (tallow), hog fat (lard), turkey fat, fish fat/oil, and chicken fat. The animal fats can be obtained from any suitable source, including restaurants and meat production facilities. According to embodiments described herein, animal fats can also include processed animal fat material. Non-limiting examples of processed animal fat material include fatty acids and fatty acid alkyl esters. Alkyl esters typically include C₁-C₅ alkyl esters. One or more of methyl, ethyl, and propyl esters are preferred.

Algae oils or lipids are typically contained in algae in the form of membrane components, storage products, and metabolites. Certain algal strains, particularly microalgae such as diatoms and cyanobacteria, contain proportionally high levels of lipids. Algal sources for the algae oils can contain varying amounts, e.g., from 2 wt % to 40 wt % of lipids, based on the total weight of the biomass itself. Algal sources for algae oils include, but are not limited to, unicellular and multicellular algae. Examples of such algae include rhodophyte, chlorophyte, heterokontophyte, tribophyte, glaucophyte, chlorarachniophyte, euglenoid, haptophyte, cryptomonad, dinoflagellum, phytoplankton, and the like, and combinations thereof. In one embodiment, algae can be of the classes Chlorophyceae and/or Haptophyta. Specific species can include, but are not limited to, Neochloris oleoabundans, Scenedesmus dimorphus, Euglena gracilis, Phaeodactylum tricornutum, Pleurochrysis carterae, Prymnesium parvum, Tetraselmis chuff, and Chlamydomonas reinhardtii.

Moreover, according to embodiments described herein, the bio-derived feedstock can include any feedstock that consists primarily of triglycerides and free fatty acids (FFAs). The triglycerides and FFAs typically contain aliphatic hydrocarbon chains in their structure having from 8 to 36 carbons, or preferably from 10 to 26 carbons, or most preferably from 14 to 22 carbons. Types of triglycerides can be determined according to their fatty acid constituents. The fatty acid constituents can be readily determined using Gas Chromatography (GC) analysis. This analysis involves extracting the fat or oil, saponifying (hydrolyzing) the fat or oil, preparing an alkyl (e.g., methyl) ester of the saponified fat or oil, and determining the type of (methyl) ester using GC analysis. In one embodiment, a majority (i.e., greater than 50%) of the triglyceride present in the lipid material can consist of C₁₀ to C₂₆ fatty acid constituents, based on the total triglyceride present in the lipid material.

Furthermore, a triglyceride is a molecule having a structure substantially identical to the reaction product of glycerol and three fatty acids. Thus, although a triglyceride is described herein as consisting of fatty acids, it should be understood that the fatty acid component does not necessarily contain a carboxylic acid hydrogen. In one embodiment, a majority of triglycerides present in the biocomponent feed can preferably consist of C₁₂ to C₁₈ fatty acid constituents, based on the total triglyceride content. Other types of feeds that are derived from biological raw material components can include fatty acid esters, such as fatty acid alkyl esters (e.g., FAME and/or FAEE).

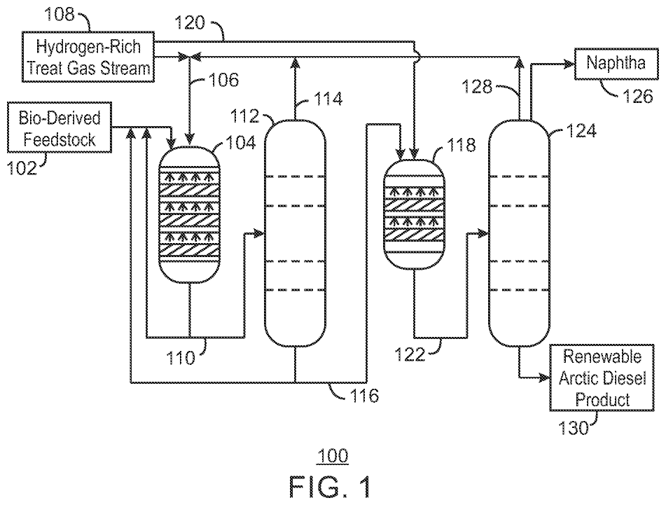

Bio-derived feedstocks, such as, for example, hydrogenated vegetable oil (HVO) and nC18 FAME, have excellent cetane ratings but poor cold flow properties. Thus, in order to meet fuel specifications, the cold flow properties must be improved. Accordingly, the cold flow properties (and various other properties) of the bio-derived feedstock may be improved by processing the bio-derived feedstock within a reaction system, such as the exemplary reaction system described with respect to FIG. 1. The following sections provide exemplary process options and conditions that may be used for the reaction system.

### Hydrotreatment Process Options According to Embodiments Described Herein

According to embodiments described herein, the feedstock undergoes a hydrotreatment process prior to undergoing a deep dewaxing process. In various embodiments, the hydrotreatment process is used to remove heteroatoms, such as oxygen, sulfur, and nitrogen, from the feedstock. The hydrotreatment process can also be used to saturate olefins. This may be accomplished using any suitable type of reactor arranged in any suitable configuration. For example, in some embodiments, the hydrotreatment reactor is an adiabatic fixed-bed reactor.

A hydrotreatment catalyst can contain at least one of Group VIB and/or Group VIII metals, optionally on a support such as alumina or silica. Examples include, but are not limited to, NiMo, CoMo, and NiW supported catalysts. In some embodiments, NiMo and Mo on alumina are preferred catalysts.

Effective hydrotreatment conditions can be selected according to the details of each specific implementation. In a preferred embodiment, the hydrotreatment conditions include a total pressure of about 200 psig to about 5,000 psig, a weighted average bed temperature (WABT) of about 260° C. (i.e., about 500° F.) to about 400° C. (i.e., about 752° F.), a hydrogen-rich treat gas rate of about 200 standard cubic feet of gas per barrel of feedstock (scf/bbl) to about 10,000 scf/bbl, and a liquid hourly space velocity (LHSV) of about 0.1 hr⁻¹ to about 10.0 hr⁻¹. Moreover, in the preferred embodiment, the oxygen content of the resulting hydrotreated feedstock is less than about 0.4 wt % or, most preferably, less than about 0.1 wt % to allow for optimal catalytic dewaxing activity, but greater than about 10 parts per million (ppm). Without being bound by any particular theory, it is believed that residual oxygenates in the hydrotreated feedstock convert to H₂O and CO during the deep dewaxing process, thus inhibiting the isomerization activity of the isomerization/dewaxing catalyst.

Further, in some embodiments, the hydrotreating conditions can include, but are not limited to, a temperature of about 260° C. to about 425° C., a total pressure of about 200 pounds per square inch in gauge (psig) (i.e., about 1.4 megapascals in gauge (MPag)) to about 5,000 psig (i.e., about 34.5 MPag), an LHSV of about 0.1 hr⁻¹ to about 10.0 hr⁻¹, and a hydrogen-rich treat gas rate of about 200 scf/bbl (i.e., about 35 Nm³/m³) to about 10,000 scf/bbl (i.e., about 1,700 Nm³/m³).

In some embodiments, the sulfur and nitrogen contents of the feedstock may be advantageously reduced during the hydrotreatment process. For example, in some embodiments, the hydrotreatment process reduces the sulfur content of the feedstock to a suitable level, such as, for example, less than about 100 weight parts per million (wppm), less than about 50 wppm, less than about 30 wppm, less than about 25 wppm, less than about 20 wppm, less than about 15 wppm, or less than about 10 wppm. In other embodiments, the hydrotreatment process reduces the sulfur content of the feedstock to less than about 5 wppm or less than about 3 wppm. With regard to nitrogen, in some embodiments, the hydrotreatment process reduces the nitrogen content of the feedstock to a suitable level, such as, for example, about 30 wppm or less, about 25 wppm or less, about 20 wppm or less, about 15 wppm or less, about 10 wppm or less, about 5 wppm or less, or about 3 wppm or less.

In various embodiments, the hydrotreatment process is also used to deoxygenate the feedstock. Deoxygenating the feedstock may help to avoid problems with catalyst poisoning or deactivation due to the creation of water (H₂O) or carbon oxides (e.g., CO and CO₂) during catalytic dewaxing. Accordingly, the hydrotreatment process can be used to remove, for example, at least 90%, at least 95%, at least 98%, at least 99%, at least 99.5%, at least 99.9%, or completely (measurably) all of the oxygen present in the biocomponent feedstock. Alternatively, the oxygenate level of the feedstock can be reduced to, for example, 0.1 wt % or less, 0.05 wt % or less, 0.03 wt % or less, 0.02 wt % or less, 0.01 wt % or less, 0.005 wt % or less, 0.003 wt % or less, 0.002 wt % or less, or 0.001 wt % or less.

### Separation Process Options According to Embodiments Described Herein

In various embodiments, because the hydrotreatment process is performed prior to the deep dewaxing process, a separation device can be used to separate out impurities from the hydrotreated feedstock prior to passing the hydrotreated feedstock to the isomerization/dewaxing reactor. In particular, the separation process minimizes the amount of H₂O and CO that is slipped into the isomerization/dewaxing reactor by separating the gas and liquid phases within the hydrotreated feedstock. While an interstage stripper is preferred for this purpose, any suitable separation device can be used, such as, for example, any suitable type of separator or fractionator that is configured to separate gas-phase products from liquid-phase products.

In various embodiments, the gas phase exiting the separation device is preferably recycled and combined with the hydrogen-rich treat gas that is fed into the hydrotreatment reactor. In addition, in various embodiments, a portion of the liquid phase exiting the separate device is also recycled back into the hydrotreatment reactor to provide improved heat release control for the hydrotreatment reactor.

### Isomerization/Dewaxing Catalyst Used According to Embodiments Described Herein

According to embodiments described herein, an acidic zeolite isomerization/dewaxing catalyst is used during the deep dewaxing process to reduce the cloud point of the hydrotreated feedstock to a sufficient degree to meet the cloud point specifications for arctic diesel. Specifically, the acidic zeolite isomerization/dewaxing catalyst includes the zeolite ZSM-48, which is a 10-member ring, one-dimensional molecular sieve of the MRE framework type. ZSM-48 is highly selective for isomerization of bio-derived feedstocks during a deep dewaxing process that requires a change in cloud point of over around 50° C. This is due to the excellent ability of ZSM-48 to produce multi-branch isomers. Moreover, high diesel selectivity may be achieved using the ZSM-48-based isomerization/dewaxing catalyst, resulting in, for example, a 138° C. conversion of less than around 4 wt % for a change in cloud point (ΔCP) of around 50° C., or less than around 6 wt % for a ΔCP of around 60° C. Accordingly, unexpectedly high diesel yields are achieved using the ZSM-48-based isomerization/dewaxing catalyst.

In some embodiments, the ZSM-48-based isomerization/dewaxing catalyst is stacked with another catalyst that selectively cracks high-molecular-weight molecules, such as, for example, a zeolite-Beta-based dewaxing catalyst. This may be particularly useful for embodiments in which the renewable arctic diesel product is intended to meet cloud point specifications for the most extreme grades of arctic diesel, such as arctic diesel that is expected to satisfy FBP, T90 distillation characteristics. In such embodiments, the ZSM-48-based isomerization/dewaxing catalyst may include, for example, some proportion of ZSM-23, ZSM-35, Beta, USY, and/or ZSM-5, in combination with the ZSM-48. In addition, in various embodiments, the ZSM-48-based isomerization/dewaxing catalyst contains a metal component including, for example, one or more Group VIA or Group VIII metals (such as, in particular, platinum or other Group VIII noble metals) on a support or binder (such as alumina, platinum, titania, silica, silica-alumina, zirconia, or a combination thereof).

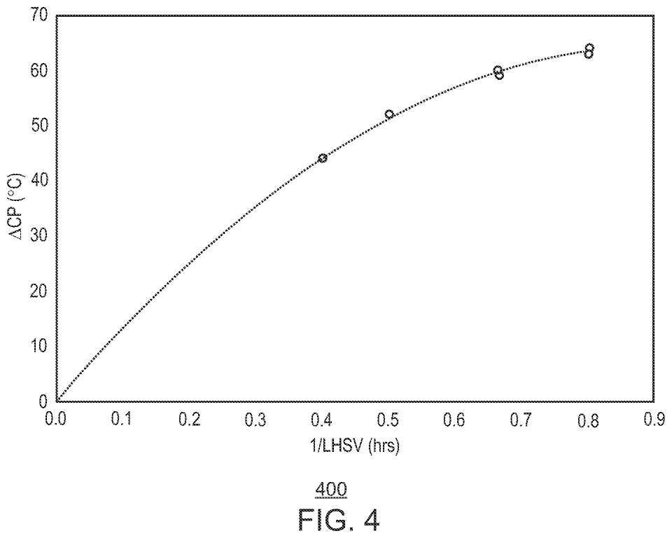

Furthermore, in various embodiments, the ZSM-48-based isomerization/dewaxing catalyst is provided by ExxonMobil's Mobil Isomerization Dewaxing (MIDW™) catalyst technology, which is designed to provide higher yields of low cloud-point diesels. Through isomerizing paraffins instead of cracking them, this technology also enhances cetane and volume swell compared to other technologies that rely only on cracking. Moreover, this technology is described by various patents, including U.S. Pat. No. 7,261,805 B2 and U.S. Pat. No. 8,674,160 B2, as well as various patent applications, including U.S. Patent Application Publication No. 2020/0063042 A1. Furthermore, more details relating to the ZSM-48-based isomerization/dewaxing catalyst are provided with respect to FIGS. 4-6.

### Deep Dewaxing Process Options According to Embodiments Described Herein

In various embodiments, after the hydrotreated feedstock exits the hydrotreatment reactor (and, optionally, the interstage stripper or other separation device), the hydrotreated feedstock is passed into an isomerization/dewaxing reactor that is configured to isomerize and/or remove long-chain, paraffinic molecules from the hydrotreated feedstock using the ZSM-48-based isomerization/dewaxing catalyst. This deep dewaxing of the hydrotreated feedstock produces a renewable arctic diesel product that meets arctic diesel cold flow specifications at unexpectedly high cetane ratings and high yields. Moreover, according to embodiments described herein, dewaxing via isomerization of the long-chain paraffinic molecules is preferred. However, some amount of cracking may also be used to reduce the cloud point below cloud point specifications, especially for the most extreme grades of arctic diesel.

The isomerization/dewaxing reactor may include any suitable type of reactor arranged in any suitable configuration. For example, in some embodiments, the isomerization/dewaxing reactor is a fixed-bed adiabatic reactor that is loaded with the ZSM-48-based isomerization/dewaxing catalyst.

In various embodiments, the deep dewaxing process is performed by exposing the hydrotreated feedstock to the ZSM-48-based isomerization/dewaxing catalyst under effective to isomerization/dewaxing conditions. Moreover, effective isomerization/dewaxing conditions can be selected according to the details of each specific implementation. In a preferred embodiment, the isomerization/dewaxing conditions include a total pressure of about 200 psig to about 5,000 psig, a WABT of about 260° C. (i.e., about 500° F.) to about 400° C. (i.e., about 752° F.), a treat gas rate of about 200 scf/bbl to about 10,000 scf/bbl, and an LHSV of about 0.1 hr⁻¹ to about 10.0 hr⁻¹. Moreover, while reducing the pressure of the isomerization/dewaxing reactor increases the isomerization activity of the catalyst, any such changes must be balanced against the higher catalyst deactivation rate at lower pressures. Thus, the optimal balance may be determined based on the details of each specific implementation.

In some embodiments, the isomerization/dewaxing conditions can include, but are not limited to, a temperature of, for example, at least about 500° F. (i.e., about 260° C.), at least about 550° F. (i.e., about 288° C.), at least about 600° F. (i.e., about 316° C.), or at least about 650° F. (i.e., about 343° C.). Additionally or alternatively, the temperature can be, for example, about 750° F. (i.e., about 399° C.) or less, about 700° F. (i.e., about 371° C.) or less, or about 650° F. (i.e., about 343° C.) or less. Effective isomerization/dewaxing conditions can additionally or alternatively include, but are not limited to, a total pressure of, for example, at least about 200 psig (i.e., about 2.8 MPag), at least about 500 psig (i.e., about 3.4 MPag), at least about 750 psig (i.e., about 5.2 MPag), or at least about 1,000 psig (i.e., about 6.9 MPag). Additionally or alternatively, the total pressure can be, for example, about 1,500 psig (i.e., about 10.3 MPag) or less, about 1,200 psig (i.e., about 8.2 MPag) or less, about 1,000 psig (i.e., about 6.9 MPag) or less, or about 800 psig (i.e., about 5.5 MPag) or less. Effective isomerization/dewaxing conditions can additionally or alternatively include, but are not limited to, an LHSV of, for example, at least about 0.5 hr⁻¹, at least about 1.0 hr⁻¹, at least about 1.5 hr⁻¹, or at least about 2.0 hr⁻¹. Additionally or alternatively, the LHSV can be, for example, about 10 hr⁻¹ or less, about 5.0 hr⁻¹ or less, about 3.0 hr⁻¹ or less, or about 2.0 hr⁻¹ or less. Effective isomerization/dewaxing conditions can additionally or alternatively include, but are not limited to, a treat gas rate of, for example, at least about 500 scf/bbl (i.e., about 84 Nm³/m³), at least about 750 scf/bbl (i.e., about 130 Nm³/m³), or at least about 1,000 scf/bbl (i.e., about 170 Nm³/m³). Additionally or alternatively, the treat gas rate can be, for example, about 3,000 scf/bbl (i.e., about 510 Nm³/m³) or less, about 2,000 scf/bbl (i.e., about 340 Nm³/m³) or less, about 1,500 scf/bbl (i.e., about 250 Nm³/m³) or less, or about 1,250 scf/bbl (i.e., about 210 Nm³/m³) or less.

In addition to improving the cold flow properties of the hydrotreated feedstock via reduction of the cloud point, the deep dewaxing process may improve the properties of the hydrotreated feedstock in several other ways. Specifically, the deep dewaxing process may remove additional oxygen from the feedstock. In addition, the deep dewaxing process may at least partially saturate the olefins in the feedstock. Moreover, the deep dewaxing process may remove additional sulfur and/or nitrogen from the feedstock.

### Fractionation Process Options According to Embodiments Described Herein

In various embodiments, the isomerized product exiting the isomerization/dewaxing reactor undergoes a fractionation process to separate the isomerized product into a relatively light fraction including naphtha and C₁ to C₄ hydrocarbons and a relatively heavy fraction including the renewable arctic diesel product. Separating the relatively light fraction from the final renewable arctic diesel product allows the product to meet diesel flash point specifications. In various embodiments, this fractionation process may be accomplished using any suitable type of fractionator (or distillation column).

In various embodiments, this fractionation process includes several steps. First, the isomerized product is partially cooled and then flowed into a high-pressure, high temperature separator (HTHPS) to provide for separation of the gas phase products and the liquid phase products. Second, the HTHPS gas phase products are further cooled and sent to a high-pressure, low-temperature separator (LTHPS), while the HTPHS liquid phase products are sent to a fractionator. Third, the cooled HTHPS gas phase products are further separated into gas phase products and liquid phase products within the LTHPS. The LTHPS gas phase products are recycled to the hydrotreatment stage within the reaction system, while the LTHPS liquid phase products are sent to a fractionator. Fourth, the liquid phase products from the HTHPS and LTHPS are fractionated into a gas phase product (e.g., tail gas), a light liquid phase product (i.e., a renewable naphtha product) and a heavy liquid phase product (i.e., a renewable artic diesel product) within the fractionator, where the gas product and the naphtha product are recovered in the overhead partial condenser and the renewable arctic diesel product is drawn from the fractionator bottom.

### Renewable Arctic Diesel Product According to Embodiments Described Herein

The renewable arctic diesel produced according to embodiments described herein includes primarily isoparaffins with a low cloud point, such as, for example, a cloud point of about −20° C. or less or about −30° C. or less. The renewable arctic diesel product also includes a high cetane rating, such as, for example, a cetane rating of about 75 or above, a cetane rating of about 80 or above, a cetane rating of about 85 or above, or a cetane rating of about 90 or above. In addition, the renewable arctic diesel product includes a high diesel yield, such as, for example, a diesel yield of around 80 wt % or above, a diesel yield of around 85 wt % or above, or a diesel yield of around 90 wt % or above, or a diesel yield of around 95 wt % or above. These properties make the renewable arctic diesel product an excellent blending component to be used in arctic diesel products that are suitable for use in extremely cold environments.

### Exemplary Reaction System for Producing Renewable Arctic Diesel According to Improved Methods Described Herein

FIG. 1 is a schematic view of an exemplary reaction system 100 for producing renewable arctic diesel according to embodiments described herein. As shown in FIG. 1, a bio-derived feedstock 102 is introduced into a hydrotreatment reactor 104. A first portion 106 of a hydrogen-rich treat gas stream 108 is also introduced into the hydrotreatment reactor 104. It will be appreciated by one of skill in the art that, while the hydrogen-rich treat gas stream 108 is depicted in FIG. 1 as entering the top of the hydrotreatment reactor 104, this is for the sake of simplicity only. In operation, the hydrogen-rich treat gas stream 108 may be introduced into the hydrotreatment reactor 104 at various locations, such as at the quench locations corresponding to each reactor bed in FIG. 1.

The bio-derived feedstock 102 is then exposed to effective hydrotreatment conditions in the hydrotreatment reactor 104 in the presence of one or more catalyst beds that contain a suitable hydrotreating catalyst, resulting in the generation of a hydrotreated feedstock 110. At least a portion of the hydrotreated feedstock 110 exiting the hydrotreatment reactor is then introduced into a separation device 112, such as an interstage stripper. Within the separation device 112, gas phase products are separated from liquid phase products. The gas phase products are then output as a first overhead stream 114 that is preferably recycled and combined with the first portion 106 of the hydrogen-rich treat gas stream 108 entering the hydrotreatment reactor 104. In addition, the liquid phase products are output as a liquid stream 116.

As shown in FIG. 1, some portion of the liquid stream 116 may (optionally) be recycled back into the hydrotreatment reactor 104 to provide heat release control for the hydrotreatment reactor 104. The rest of the liquid stream 116 (or the entirety of the liquid stream 116 for embodiments that do not include liquid recycling) is then introduced into an isomerization/dewaxing reactor 118. A second portion 120 of the hydrogen-rich treat gas stream 108 is also introduced into the isomerization/dewaxing reactor 118. It will be appreciated by one of skill in the art that, while the hydrogen-rich treat gas stream 108 is depicted in FIG. 1 as entering the top of the isomerization/dewaxing reactor 118, this is for the sake of simplicity only. In operation, the hydrogen-rich treat gas stream 108 may be introduced into the isomerization/dewaxing reactor 118 at various locations, such as at the quench locations corresponding to each reactor bed in FIG. 1.

Within the isomerization/dewaxing reactor 118, the liquid stream 116 is exposed to suitable catalytic isomerization/dewaxing conditions in the presence of one or more catalyst beds that contain a ZSM-48-based isomerization/dewaxing catalyst, resulting in the generation of an isomerized product stream 122. Finally, the isomerized product stream 122 exiting the isomerization/dewaxing reactor 118 is flowed through a fractionator 124. Within the fractionator 124, the isomerized product stream 122 is separated into a relatively light fraction including naphtha 126 and gas phase products 128 (e.g., C₁ to C₄ hydrocarbons) and a relatively heavy fraction including a renewable artic diesel product 130 that meets cloud point specifications for extremely cold environments at a high cetane rating and a high yield. In some embodiments, the gas phase products 128 are recycled and combined with the first portion 106 of the hydrogen-rich treat gas stream 108 entering the hydrotreatment reactor 104, while the renewable artic diesel product 130 is output as the final product of the reaction system 100.

The schematic view of FIG. 1 is not intended to indicate that the reaction system 100 is to include all of the components shown in FIG. 1, or that the reaction system 100 is limited to only the components shown in FIG. 1. Rather, any number of components may be omitted from the reaction system 100, or added to the reaction system 100, depending on the details of the specific implementation. For example, in some embodiments, the separation device 112 is omitted from the reaction system 100, and the hydrotreated feedstock is passed directly from the hydrotreatment reactor 104 to the isomerization/dewaxing reactor 118. In addition, in some embodiments, the fractionator 124 is omitted, and the isomerized product stream 122 is used as the final renewable arctic diesel product 130. Moreover, in some embodiments, multiple hydrotreatment reactors and/or multiple isomerization/dewaxing reactors are included within the reaction system 100. Furthermore, it will be appreciated that the reaction system 100 is susceptible to any number of other modifications or variations without changing the overall technical effect of the system. For example, while the reaction system 100 of FIG. 1 is depicted as including separate hydrotreatment and isomerization/dewaxing reactors 104 and 118, respectively, one of skill in the art will appreciate that the hydrotreatment and isomerization/dewaxing stages can alternatively be combined into a single reactor without changing the overall technical effect of the reaction system 100.

### Experimental Implementation of Improved Method for Renewable Arctic Diesel Production According to Embodiments Described Herein

During an experimental implementation of the techniques described herein, a bio-derived feedstock including hydrogenated vegetable oil was hydrotreated within a fixed-bed isothermal reactor using a commercially-available NiMo hydrotreating catalyst. The resulting hydrotreated feedstock included a density of 0.7898 g/cc, a sulfur content of less than 5 wppm, a nitrogen content of less than 10 wppm, an oxygen content of 0.39 wt %, a cloud point of 25° C., and a T5 of 287° C., a T50 of 318° C., and a T95 of 349° C.

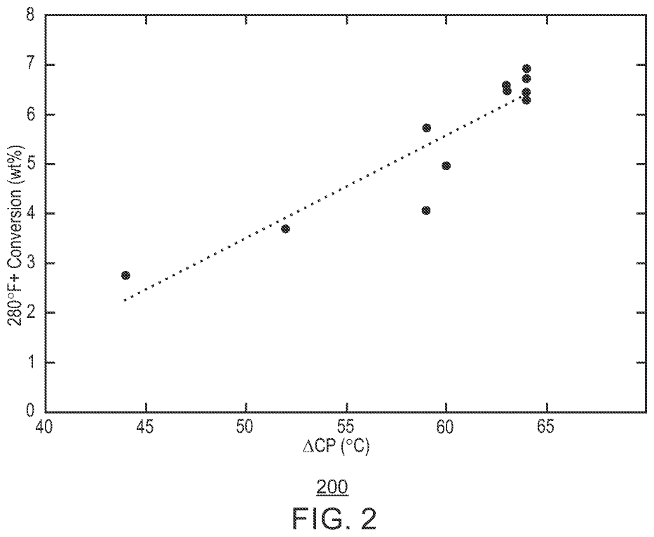

The hydrotreated feedstock was then deeply dewaxed within a fixed-bed isothermal reactor using a ZSM-48-based isomerization/dewaxing catalyst including platinum. The isomerization/dewaxing conditions included a temperature of 329° C. (i.e., 625° F.), a pressure of 600 psig, a treat gas rate of 800 scf/bbl, and an LHSV that was varied to target changes in cloud point ranging from approximately −45° C. to −65° C. The resulting renewable arctic diesel product was collected and analyzed, as described further with respect to FIG. 2.

Specifically, FIG. 2 is a graph 200 showing the 138° C. conversion of the feedstock during the deep dewaxing process as a function of the change in cloud point (ΔCP). As shown in the graph 200, even at the highest ΔCP tested (which was 64° C.), the 138° C. conversion was less than 7 wt %. This corresponds to a diesel yield of approximately 93 wt % or above, assuming that 100% of the feed boils above 138° C. Accordingly, the techniques described herein result in unexpectedly high yields for large changes in cloud point, making such techniques ideal for producing renewable arctic diesel that meets cloud point specifications for extremely cold environments.

As part of the experimental implementation, a blend of the renewable arctic diesel product with a cloud point of −37° C. was distilled to produce a 160° C.+ diesel fraction. The diesel fraction was then collected and analyzed. This analysis revealed that the diesel fraction had a cloud point of −36° C. and a cetane rating of 91. Thus, the cloud point of the diesel fraction was almost identical to the cloud point of the renewable arctic diesel product, confirming that the techniques described herein (and, in particular, the ZSM-48-based isomerization/dewaxing catalyst) are highly selective for isomerization since removal of the 160° C.− fraction produced by cracking did not appreciably affect the cloud point of the 160° C.+ diesel fraction. Moreover, the resulting diesel fraction exceeds the cloud point specification for EN 590 Class 4 Arctic Diesel, which requires a cloud point of −34° C. or less.

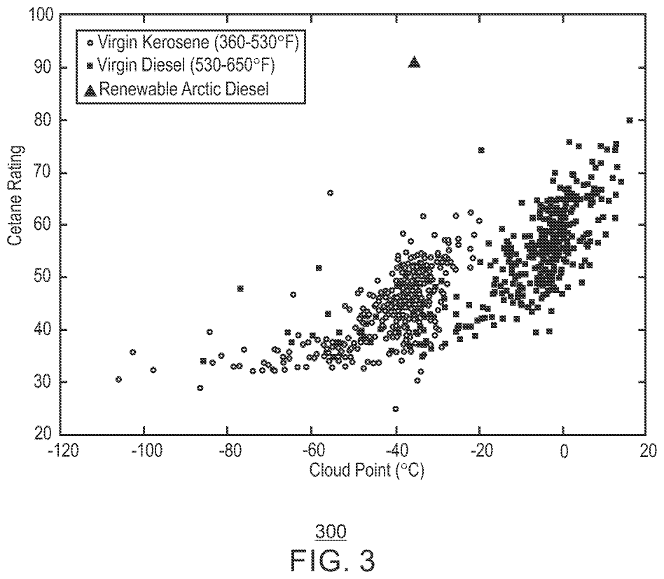

FIG. 3 is a graph 300 showing a comparison between the cetane rating and cloud point for the renewable arctic diesel described herein versus the cetane ratings and cloud points for the kerosene and diesel fractions of several hundred crudes that may be used to produce conventional arctic diesel. Specifically, the cetane rating (estimated as cetane index by D4737 Procedure A) was plotted as a function of cloud point (in ° C.) for the virgin kerosene fractions of several hundred crudes (as shown by the circles in the graph 300), as well as for the virgin diesel fractions of several hundred crudes (as shown by the squares in the graph 300). Moreover, the cetane rating for the renewable arctic diesel produced according to the experimental implementation of the techniques described herein was also plotted as a function of cloud point (as shown by the triangle in the graph 300). The graph 300 clearly reveals that the combination of high cetane rating and low cloud point observed in the renewable arctic diesel described herein is not observed in the mineral kerosene or diesel fractions used to produce conventional arctic diesel. As a result, embodiments described herein are uniquely adapted to produce high-cetane, high-yield renewable arctic diesel with excellent cold flow properties.

### Additional Properties of ZSM-48-Based Isomerization/Dewaxing Catalyst

The following information relates to properties of the ZSM-48-based isomerization/dewaxing catalyst, as evidenced by an experimental implementation wherein the isomerization/dewaxing reactor was a fixed-bed isothermal reactor loaded with the ZSM-48-based isomerization/dewaxing catalyst, diluted with alumina.

FIG. 4 is a graph 400 showing the change in cloud point (ΔCP) as a function of the inverse liquid hourly space velocity (i.e., 1/LHSV). The graph 400 reveals that the ΔCP increases as the LHSV decreases. This is due to the fact that a lower LHSV increase the residence time within the isomerization/dewaxing reactor.

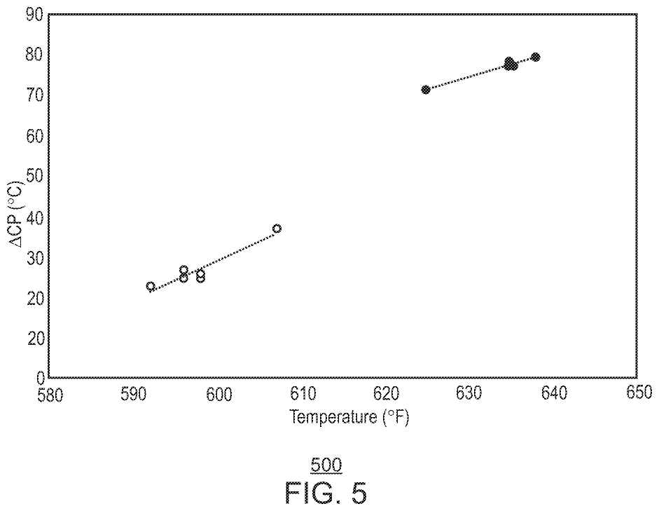

FIG. 5 is a graph 500 showing the ΔCP as a function of the temperature (in ° F.). The graph 500 reveals that the ΔCP increase as the temperature increases. For example, in some embodiments, an increase in temperature of around 1° C. corresponds to a ΔCP (i.e., feed cloud point minus product cloud point) increase of around 1.5° C. This is due to the fact that the isomerization activity of the ZSM-48-based isomerization/dewaxing catalyst increases as the temperature increases.

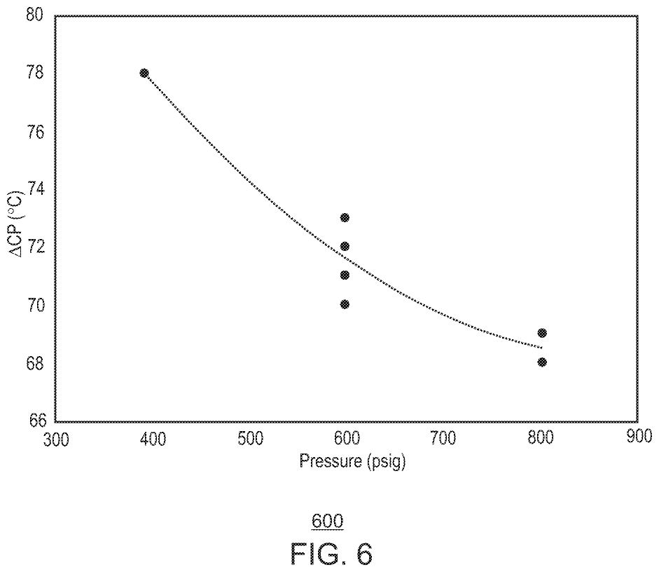

FIG. 6 is a graph 600 showing the ΔCP as a function of the pressure (in psig). The graph 600 reveals that the ΔCP increase as the pressure decreases. For example, in some embodiments, an increase in pressure of around 200 psig corresponds to a ΔCP decrease of around 5° C. However, because excessively low pressures inhibit the isomerization activity of the ZSM-48-based isomerization/dewaxing catalyst, any pressure reductions must be balanced against the higher catalyst deactivation rate at lower pressures.

In various embodiments, the isomerization activity of the ZSM-48-based isomerization/dewaxing catalyst is also inhibited by any residual oxygen that is slipped from the hydrotreatment reactor to the isomerization/dewaxing reactor. Therefore, it is critical to control the amount of CO, CO₂, and H₂O that is fed into the isomerization/dewaxing reactor in order to maximize the effectiveness of the deep dewaxing process.

For some embodiments in which the renewable arctic diesel product is intended to meet cloud point specifications for the most extreme grades of arctic diesel, a target ΔCP of around 60° C. or more may be desirable. Accordingly, in various embodiments, the ZSM-48-based isomerization/dewaxing catalyst is stacked with another catalyst, such as a commercial zeolite Beta catalyst, that selectively cracks high-molecular-weight molecules. In this manner, a combination of isomerization and cracking may be utilized to achieve very high ΔCPs within the isomerization/dewaxing reactor.

### Improved Methods for Renewable Arctic Diesel Production

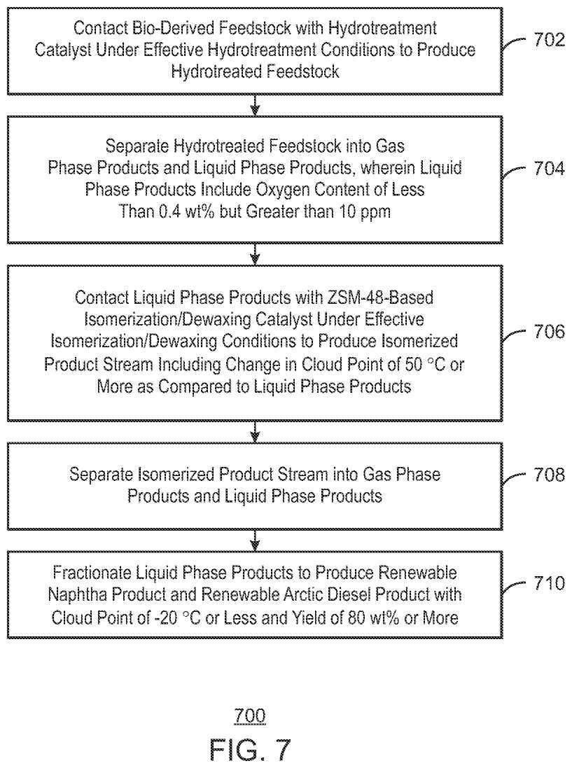

FIG. 7 is a process flow diagram of a method 700 for producing renewable arctic diesel according to embodiments described herein. In various embodiments, the method 700 may be implemented within a suitable reaction system, such as the reaction system 100 described with respect to FIG. 1 (or any suitable variations thereof). The method 700 begins at block 702, at which a bio-derived feedstock is contacted with a hydrotreatment catalyst under effective hydrotreatment conditions to produce a hydrotreated feedstock. The effective hydrotreatment conditions may include, for example, a pressure of 200-5,000 pounds per square inch in gauge (psig), a weighted average bed temperature (WABT) of 260-400° C., a hydrogen-rich treat gas rate of 200-10,000 standard cubic feet of gas per barrel (scf/bbl), and a liquid hourly space velocity (LHSV) of 0.1-10.0 inverse hours (hr⁻¹). In some embodiments, block 702 also includes exposing the bio-derived feedstock to a first portion of a hydrogen-rich treat gas stream along with the hydrotreatment catalyst, where the first portion of the hydrogen-rich treat gas stream may include recycled gas phase products from the reaction system.

At block 704, the hydrotreated feedstock is separated into gas phase products and liquid phase products, wherein the liquid phase products include an oxygen content of less than 0.4 wt % but greater than 10 ppm. This may be accomplished using any suitable type of separation device.

At block 706, the liquid phase products are contacted with a ZSM-48-based isomerization/dewaxing catalyst under effective isomerization/dewaxing conditions to produce an isomerized product stream including a change in cloud point (ΔCP) of 50° C. or more as compared to the liquid phase products. The effective isomerization/dewaxing conditions may include, for example, a pressure of 200-5,000 pounds per square inch in gauge (psig), a weighted average bed temperature (WABT) of 260-400° C., a hydrogen-rich treat gas rate of 200-10,000 standard cubic feet of gas per barrel (scf/bbl), and a liquid hourly space velocity (LHSV) of 0.1-10.0 inverse hours (hr⁻¹). In addition, in some embodiments, the method 700 includes determining the pressure for the effective isomerization/dewaxing conditions by balancing the higher isomerization activity of the ZSM-48-based isomerization/dewaxing catalyst at lower pressures against the lower catalyst deactivation rate for the ZSM-48-based isomerization/dewaxing catalyst at higher pressures. Moreover, in some embodiments, block 706 also includes exposing the liquid phase products to a second portion of the hydrogen-rich treat gas stream along with the ZSM-48-based isomerization/dewaxing catalyst.

In some embodiments, the method 700 includes stacking the ZSM-48-based isomerization/dewaxing catalyst with a catalyst that selectively cracks high-molecular-weight molecules. In such embodiments, the liquid phase products are contacted with the stacked ZSM-48-based isomerization/dewaxing catalyst to allow for a controlled combination of isomerization and cracking that provides the ΔCP of 50° C. or more.

At block 708, the isomerized product stream is separated into gas phase products and liquid phase products. In addition, at block 710, the liquid phase products are fractionated to produce a renewable naphtha product and a renewable arctic diesel product with a cloud point of −20° C. or less and a yield of 80 wt % or more. This may be accomplished using any suitable type of fractionator or other separation device. In various embodiments, the effective isomerization/dewaxing conditions at block 706 are determined such that the cloud point of the renewable arctic diesel product meets arctic diesel cloud point specifications. Moreover, in some embodiments, the resulting renewable arctic diesel product includes a cetane rating of 85 or above.

In some embodiments, the method 700 includes contacting the bio-derived feedstock with the hydrotreatment catalyst within a hydrotreatment reactor and contacting the liquid phase products with the ZSM-48-based isomerization/dewaxing catalyst within a separate isomerization/dewaxing reactor, as described further with respect to FIG. 7. In other embodiments, the method 700 includes contacting the bio-derived feedstock with the hydrotreatment catalyst and contacting the resulting hydrotreated effluent (i.e., the gas and liquid phase products from the hydrotreatment stage) with the ZSM-48-based isomerization/dewaxing catalyst within a single reactor including one or more hydrotreatment stages and one or more isomerization/dewaxing stages.

The process flow diagram of FIG. 7 is not intended to indicate that the steps of the method 700 are to be executed in any particular order, or that all of the steps of the method 700 are to be included in every case. Further, any number of additional steps not shown in FIG. 7 may be included within the method 700, depending on the details of the specific implementation.

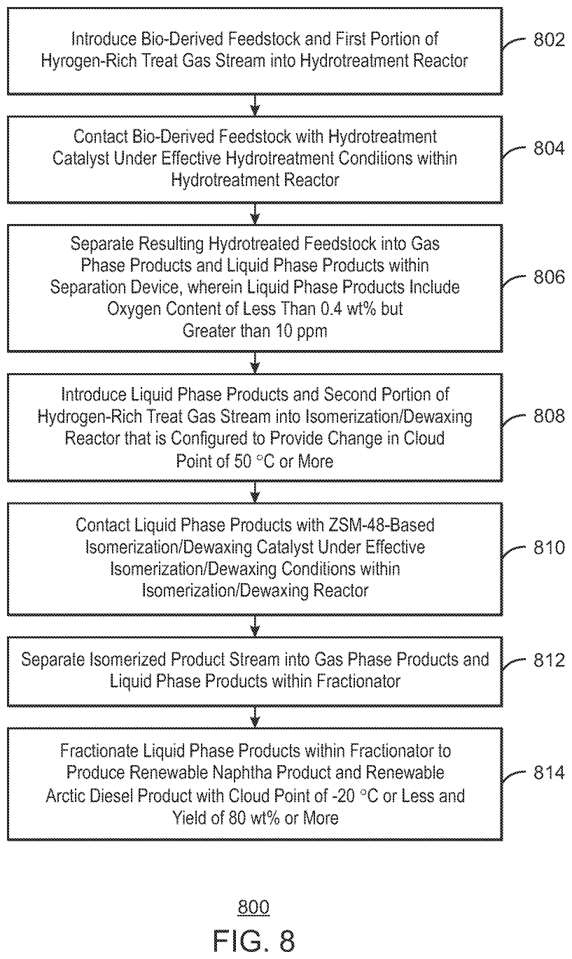

FIG. 8 is a process flow diagram of a more detailed, exemplary method 800 for producing renewable arctic diesel according to embodiments described herein. In various embodiments, the method 800 may be implemented within a suitable reaction system, such as the reaction system 100 described with respect to FIG. 1. The method 800 begins at block 802, at which a bio-derived feedstock and a first portion of a hydrogen-rich treat gas stream are introduced into a hydrotreatment reactor. In some embodiments, the method 800 also includes pretreating the bio-derived feedstock to remove metals, gums, and other contaminants.

At block 804, the bio-derived feedstock is contacted with a hydrotreatment catalyst under effective hydrotreatment conditions within the hydrotreatment reactor. In some embodiments, the bio-derived feedstock includes diglycerides, monoglycerides, triglycerides, fatty acid methyl esters (FAME), and/or free fatty acids derived from plant oils, animal fats, and/or algae oils. Moreover, in some embodiments, the hydrotreatment conditions include a pressure of 200-5,000 psig, a WABT of 260-400° C., a hydrogen-rich treat gas rate of 200-10,000 scf/bbl, and an LHSV of 0.1-10.0 hr⁻¹.

At block 806, the resulting hydrotreated feedstock is separated into gas phase products and liquid phase products within a separation device. In some embodiments, the separation device includes an interstage stripper. Moreover, according to embodiments described herein, the liquid phase products include an oxygen content of less than 0.4 wt % but greater than 10 ppm.

At block 808, the liquid phase products and a second portion of the hydrogen-rich treat gas stream are introduced into an isomerization/dewaxing reactor that is configured to provide a change in cloud point (ΔCP) of 50° C. or more. In addition, at block 810, the liquid phase products are contacted with a ZSM-48-based isomerization/dewaxing catalyst under effective isomerization/dewaxing conditions within the isomerization/dewaxing reactor. In various embodiments, the effective isomerization/dewaxing conditions include a pressure of 200-5,000 psig, a WABT of 260-400° C., a hydrogen-rich treat gas rate of 200-10,000 scf/bbl, and an LHSV of 0.1-10.0 hr⁻¹.

In some embodiments, the method 800 includes determining the pressure for the isomerization/dewaxing conditions by balancing a higher isomerization activity of the ZSM-48-based isomerization/dewaxing catalyst at lower pressures against a lower catalyst deactivation rate for the ZSM-48-based isomerization/dewaxing catalyst at higher pressures. Furthermore, in some embodiments, the method 800 includes determining the isomerization/dewaxing conditions such that the cloud point of the renewable arctic diesel product meets an arctic diesel cloud point specification.

In various embodiments, the method 800 also includes forming the ZSM-48-based isomerization/dewaxing catalyst using a metal component including, for example, one or more Group VIA or Group VIII metals (such as, in particular, platinum or other Group VIII noble metals) on a support or binder (such as alumina, platinum, titania, silica, silica-alumina, zirconia, or a combination thereof). In addition, in some embodiments, the method 800 includes stacking ZSM-48-based isomerization/dewaxing catalyst with a catalyst that selectively cracks high-molecular-weight molecules. In such embodiments, the method 800 also includes contacting the hydrotreated feedstock with the stacked ZSM-48-based isomerization/dewaxing catalyst within the isomerization/dewaxing reactor to allow for a controlled combination of isomerization and cracking that provides the ΔCP of 50° C. or more.

At block 812, the resulting isomerized product stream is separated into gas phase products and liquid phase products. In addition, at block 814, the liquid phase products are fractionated to produce a renewable naphtha product and a renewable arctic diesel product with a cloud point of −20° C. or less and a yield of 80 wt % or more. The renewable arctic diesel product includes a cloud point of −20° C. or less and a yield of 80 wt % or more. In addition, in various embodiments, the renewable arctic diesel product includes a cetane rating of 85 or above.

The process flow diagram of FIG. 8 is not intended to indicate that the steps of the method 800 are to be executed in any particular order, or that all of the steps of the method 800 are to be included in every case. Further, any number of additional steps not shown in FIG. 8 may be included within the method 800, depending on the details of the specific implementation. For example, in various embodiments, the gas phase products exiting the separation device and/or the gas phase products separated from the liquid phase products within the fractionator are combined with the first portion of the hydrogen-rich treat gas stream for recycling back into the hydrotreatment reactor.

Moreover, while the embodiments described herein are well-calculated to achieve the advantages set forth, it will be appreciated that such embodiments are susceptible to modification, variation, and change without departing from the spirit thereof. Indeed, the present techniques include all alternatives, modifications, and equivalents falling within the true spirit and scope of the appended claims

What is claimed is:

1. A method for producing renewable arctic diesel, comprising:
contacting a bio-derived feedstock with a hydrotreatment catalyst under effective hydrotreatment conditions to produce a hydrotreated feedstock;
separating the hydrotreated feedstock into first gas phase products and first liquid phase products, wherein the first liquid phase products comprise an oxygen content of less than 0.4 weight percent (wt %) but greater than 10 parts per million (ppm);
contacting the first liquid phase products with a ZSM-48-based isomerization/dewaxing catalyst under effective isomerization/dewaxing conditions to produce an isomerized product stream comprising a change in cloud point (ΔCP) of 50 degrees Celsius (° C.) or more as compared to the first liquid phase products;
separating the isomerized product stream into second gas phase products and second liquid phase products; and
fractionating the second liquid phase products to produce a renewable naphtha product and a renewable arctic diesel product with a cloud point of −20° C. or less and a yield of 80 wt % or more.

2. The method of claim 1, comprising:
contacting the bio-derived feedstock with the hydrotreatment catalyst within a hydrotreatment reactor; and
contacting the first liquid phase products with the ZSM-48-based isomerization/dewaxing catalyst within a separate isomerization/dewaxing reactor.

3. The method of claim 1, comprising contacting the bio-derived feedstock with the hydrotreatment catalyst and contacting a resulting hydrotreated effluent with the ZSM-48-based isomerization/dewaxing catalyst within a single reactor comprising one or more hydrotreatment stages and one or more isomerization/dewaxing stages.

4. The method of claim 1, comprising:
exposing the bio-derived feedstock to a first portion of a hydrogen-rich treat gas stream along with the hydrotreatment catalyst; and
exposing the first liquid phase products to a second portion of the hydrogen-rich treat gas stream along with the ZSM-48-based isomerization/dewaxing catalyst.

5. The method of claim 4, comprising recycling at least one of the first gas phase products or the second gas phase products for combination with the first portion of the hydrogen-rich treat gas stream.

6. The method of claim 1, wherein the effective hydrotreatment conditions and the effective isomerization/dewaxing conditions comprise a pressure of 200-5,000 pounds per square inch in gauge (psig), a weighted average bed temperature (WABT) of 260-400° C., a hydrogen-rich treat gas rate of 200-10,000 standard cubic feet of gas per barrel (scf/bbl), and a liquid hourly space velocity (LHSV) of 0.1-10.0 inverse hours (hr⁻¹).

7. The method of claim 1, comprising determining the pressure for the effective isomerization/dewaxing conditions by balancing a higher isomerization activity of the ZSM-48-based isomerization/dewaxing catalyst at lower pressures against a lower catalyst deactivation rate for the ZSM-48-based isomerization/dewaxing catalyst at higher pressures.

8. The method of claim 1, comprising determining the effective isomerization/dewaxing conditions such that the cloud point of the renewable arctic diesel product meets an arctic diesel cloud point specification.

9. The method of claim 1, wherein the renewable arctic diesel product comprises a cetane rating of 85 or above.

10. The method of claim 1, comprising stacking the ZSM-48-based isomerization/dewaxing catalyst with a catalyst that selectively cracks high-molecular-weight molecules.

11. The method of claim 10, comprising contacting the first liquid phase products with the stacked ZSM-48-based isomerization/dewaxing catalyst to allow for a controlled combination of isomerization and cracking that provides the ΔCP of 50° C. or more.

12. A method for producing renewable arctic diesel within a reaction system, comprising:
introducing a bio-derived feedstock and a first portion of a hydrogen-rich treat gas stream into a hydrotreatment reactor;
contacting the bio-derived feedstock with a hydrotreatment catalyst under effective hydrotreatment conditions within the hydrotreatment reactor;
separating a resulting hydrotreated feedstock into first gas phase products and first liquid phase products within a separation device, wherein the first liquid phase products comprise an oxygen content of less than 0.4 weight percent (wt %) but greater than 10 parts per million (ppm);
introducing the first liquid phase products and a second portion of the hydrogen-rich treat gas stream into an isomerization/dewaxing reactor that is configured to provide a change in cloud point (ΔCP) of 50 degrees Celsius (° C.) or more;
contacting the first liquid phase products with a ZSM-48-based isomerization/dewaxing catalyst under effective isomerization/dewaxing conditions within the isomerization/dewaxing reactor;
separating the isomerized product stream into second gas phase products and second liquid phase products within a fractionator; and
fractionating the second liquid phase products within the fractionator to produce a renewable naphtha product and a renewable arctic diesel product with a cloud point of −20° C. or less and a yield of 80 wt % or more.

13. The method of claim 12, comprising stacking the ZSM-48-based isomerization/dewaxing catalyst with a catalyst that selectively cracks high-molecular-weight molecules.

14. The method of claim 13, comprising contacting the first liquid phase products with the stacked ZSM-48-based isomerization/dewaxing catalyst within the isomerization/dewaxing reactor to allow for a controlled combination of isomerization and cracking that provides the ΔCP of 50° C. or more.

15. The method of claim 12, comprising combining the first gas phase products and the second gas phase products with the first portion of the hydrogen-rich treat gas stream for recycling back into the hydrotreatment reactor.

16. The method of claim 12, wherein the renewable arctic diesel product comprises a cetane rating of 85 or above.

17. The method of claim 12, comprising determining the pressure for the isomerization/dewaxing conditions by balancing a higher isomerization activity of the ZSM-48-based isomerization/dewaxing catalyst at lower pressures against a lower catalyst deactivation rate for the ZSM-48-based isomerization/dewaxing catalyst at higher pressures.

18. The method of claim 12, comprising determining the isomerization/dewaxing conditions such that the cloud point of the renewable arctic diesel product meets an arctic diesel cloud point specification.

19. The method of claim 12, comprising pretreating the bio-derived feedstock to remove metals, gums, and other contaminants.

20. The method of claim 12, wherein the effective hydrotreatment conditions and the effective isomerization/dewaxing conditions comprise a pressure of 200-5,000 pounds per square inch in gauge (psig), a weighted average bed temperature (WABT) of 260-400° C., a hydrogen-rich treat gas rate of 200-10,000 standard cubic feet of gas per barrel (scf/bbl), and a liquid hourly space velocity (LHSV) of 0.1-10.0 inverse hours (hr⁻¹).
